(19) United States
(12) Patent Application Publication
(10) Pub. No.: US 2014/0182352 A1
(43) Pub. Date: Jul. 3, 2014

(54) System and Method for Evaluating the Functionality of a Blood Pressure Cuff

(71) Applicant: GENERAL ELECTRIC COMPANY, Schenectady, NY (US)

(72) Inventors: Lawrence T. Hersh, Tinley Park, IL (US); Robert F. Donehoo, Colgate, WI (US); Gary J. Secora, Menomonee Falls, WI (US); Timothy R. Jubeck, Milwaukee, WI (US)

(73) Assignee: GENERAL ELECTRIC COMPANY, Schenectady, NY (US)

(21) Appl. No.: 13/728,279

(22) Filed: Dec. 27, 2012

(51) Int. Cl. G01L 27/00

(52) U.S. Cl. CPC G01L 27/007
USPC 73/1.57

(57) ABSTRACT

A system and method for evaluating the functionality of a blood pressure cuff. The system includes a support mandrel that receives a stimulation cuff connected to a blood pressure simulation device. The reference cuff is positioned around both the mandrel and the stimulation cuff and the blood pressure simulator is operated to inflate and deflate the stimulation cuff in a test pattern. A reference signal from the reference blood pressure cuff is received and stored for later analysis. Once the reference signal is recorded, a test blood pressure cuff is positioned around the stimulation cuff and the mandrel and the blood pressure simulator is operated to create the test pattern. An output signal from the test blood pressure cuff is recorded. The system compares the reference output signal to the test output signal to determine whether the test blood pressure cuff and the reference blood pressure cuff are functional equivalents.

### BACKGROUND OF THE INVENTION

The present disclosure generally relates to a method and system for evaluating the functionality of a blood pressure cuff. More specifically, the method and system of the present disclosure can be used to test the functionality of a newly designed test blood pressure cuff for oscillometric blood pressure determinations by comparing the test cuff performance to a reference blood pressure cuff when both are stimulated by the same established test patterns.

Presently, when a new model or design of a blood pressure cuff is being designed and developed, the blood pressure cuff must be tested to insure that the newly developed blood pressure cuff operates to accurately determine the blood pressure of a patient. Blood pressure cuffs used with noninvasive blood pressure (NIBP) monitors are pneumatically connected to a pressure transducer that generates an electronic output signal in response to sensed volume pulses beneath the cuff when the cuff is positioned on a patient.

Since it is important to determine the volume transducing properties of a newly developed blood pressure cuff, blood pressure cuffs are typically validated using a comparison between noninvasive blood pressure determination results using a reference cuff and a test cuff when each are positioned on a patient. Because of increasing regulations, costs and time requirements, studies with human patients are becoming an increasing burden to device manufacturers. Further, the blood pressures recorded from patients can be quite variable, making statistical strategies difficult when comparing cuff performances between a reference cuff and a test cuff. A bench testing method which has the advantage of not using patients for verifying the pulse transducing capabilities of a new test cuff is disclosed.

### SUMMARY OF THE INVENTION

The present disclosure relates to a system and method for evaluating the functionality of a test blood pressure cuff. More specifically, the present disclosure relates to a method and system that evaluates the functionality of a test blood pressure cuff by comparing the output signal from the test blood pressure cuff to a reference signal that is generated by a known reference blood pressure cuff.

The system of the disclosure includes a support mandrel that provides adequate support for both a stimulation blood pressure cuff and either a reference blood pressure cuff or a test blood pressure cuff.

The stimulation blood pressure cuff is positioned on the support mandrel and is connected to a simulation device. The simulation device is selectively operable to create a series of pulses by selectively setting the pressure and volume of the inflatable bladder of the stimulation cuff. The simulation device creates pulse volume changes in the stimulation cuff in a test pattern that generally replicates the pressure pulses in a patient. The stimulation cuff changes volume in response to the pulse volume changes received from the simulation device. Any volume changes in the stimulation cuff are then transduced by the test or reference cuff in contact with and wrapped around the stimulation cuff.

Initially, a reference blood pressure cuff is positioned around the stimulation cuff and the mandrel. The reference blood pressure cuff can be pneumatically connected to a monitoring device capable of obtaining cuff pressure waveforms. The reference blood pressure cuff changes volume in response to volume changes of the stimulation cuff that originate from a defined test pattern. The pressure transducer of the monitoring device converts the pressure changes in the reference cuff resulting from the volume changes of the test pattern in the stimulation cuff into an electronic signal that can be recorded for later evaluations.

The output signal generated by pressure changes from the reference blood pressure cuff is received and recorded as a reference signal. The reference signal from the reference blood pressure cuff is created in direct response to the test pattern from the stimulation cuff.

Once the reference signal has been created and stored, the reference blood pressure cuff is removed from the support mandrel and is replaced by a test blood pressure cuff. The test blood pressure cuff is the cuff being evaluated. Once the test blood pressure cuff is in place, the simulation device is operated to again create the same test pattern used to generate the reference signal. During the test pattern, a pressure transducer contained within the monitoring device generates a test signal that is received by a recording and analysis device. The test signal can either be stored or immediately compared to the reference signal using one or more comparison algorithms. The various different comparison algorithms are utilized to evaluate the correspondence between the test signal from the test blood pressure cuff and the reference signal from the reference blood pressure cuff.

In order to create the same test pattern the stimulation cuff is initially set to a particular pressure and volume level by connection to a sphygmomanometer inflation bulb or other pneumatic device capable of inflating a cuff. The test or reference cuff is also placed at a particular pressure and volume setting to create the configuration for producing a test pattern. The stimulation cuff pressure controls the pulse generating characteristics of the pneumatically connected NIBP simulator. By adjusting the volume and pressure characteristics of the stimulation, test, and reference cuffs the same test pattern can be created for the test and reference cuffs for comparison.

Based upon the comparison between the test signal and the reference signal, the system and method of the disclosure determine whether the test blood pressure cuff and the reference blood pressure cuff are equivalent for gathering oscillometric envelope data. Thus, the system and method of the present disclosure does not need to evaluate the pulse gathering operation of the test blood pressure cuff on a patient and thus helps eliminate the need for human trials.

### BRIEF DESCRIPTION OF THE DRAWINGS

The drawings illustrate the best mode contemplated of carrying out the disclosure. In the drawings:

FIG. 1 is an exploded schematic illustration of a support mandrel, a stimulation cuff and both a test blood pressure cuff and a reference blood pressure cuff;

FIG. 2 is a cross section view illustrating the positioning of both the stimulation cuff and the reference blood pressure cuff on the support mandrel;

FIG. 3 is a schematic illustration of the component of a system that carries out a method to evaluate the functionality of a test blood pressure cuff;

FIG. 4 is a schematic illustration of the volume displacement interface and waveforms generated utilizing the method and system of the present disclosure;

FIG. 5 is a flowchart illustrating the operational sequence to evaluate the operation of a test blood pressure cuff; and

FIG. 6 is a process and data flowchart illustrating the steps needed to compare the reference cuff pressure waveforms to test cuff pressure waveforms to determine whether the test cuff and the reference cuff are equivalent.

### DETAILED DESCRIPTION OF THE INVENTION

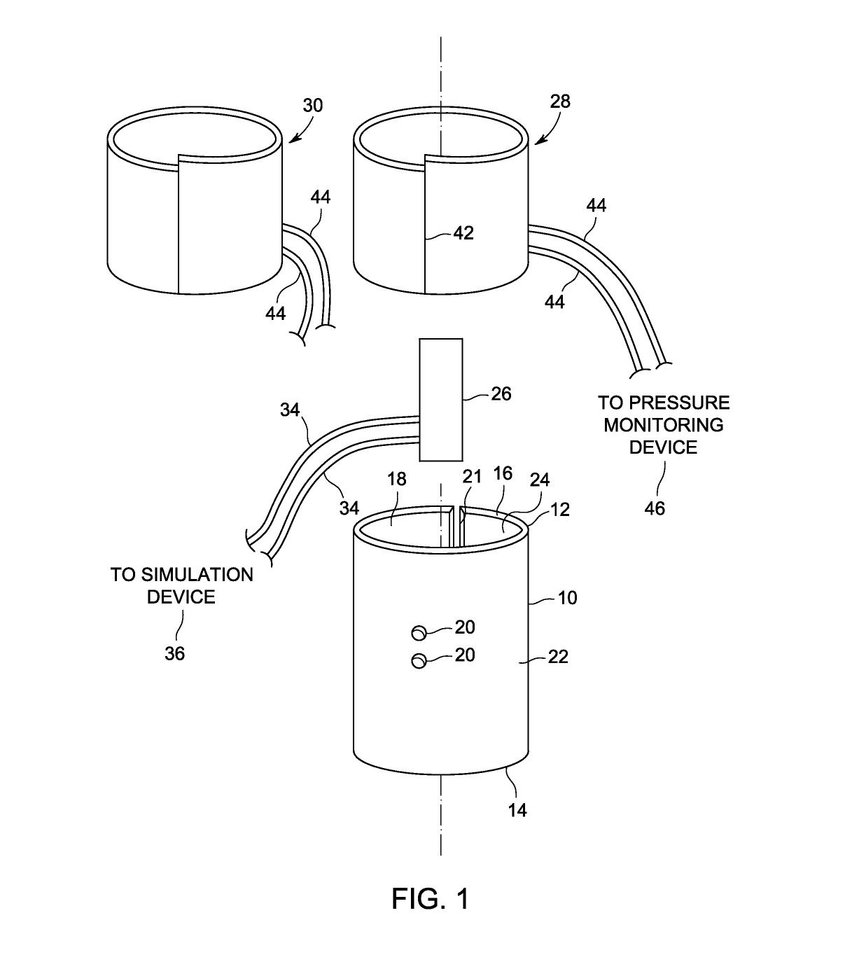

FIG. 1 illustrates a portion of a system for evaluating the functionality of a newly developed test blood pressure cuff. The system includes a support mandrel 10. The support mandrel 10 is shown in the embodiment of FIG. 1 having a generally cylindrical shape extending between a top end 12 and a bottom end 14. An outer wall 16 defines a generally open interior 18 that extends from the top end 12 to the bottom end 14. In the embodiment shown in FIG. 1, the outer wall 16 includes a pair of access openings 20 that allow pneumatic hoses to pass from the exterior of the mandrel 10 into the open interior 18. Although a pair of access openings 20 is shown in the embodiment of FIG. 1, it should be understood that various different types of openings or slots could be utilized while operating within the scope of the present disclosure.

In the embodiment shown in FIG. 1, the mandrel 10 has a defined outer diameter. However, it is contemplated that the mandrel 10 could include a split 21 running from the top end 12 to the bottom end 14 such that the diameter of the mandrel 10 could be selectively increased or decreased using a physically connected clamping mechanism depending upon the particular pressure and volume desired for the blood pressure cuff being tested. Various different clamping mechanisms could be utilized to adjust the outer diameter of the mandrel 10 while operating within the scope of the present disclosure. For example, c-clamps or attached diameter adjusting screws passing through the mandrel near the top and bottom of the mandrel could be used to control the setting of the width of the mandrel split 21.

In the embodiment shown in FIG. 1, the mandrel 10 is formed as a section of PVC tubing, which is durable and provides the required rigidity for the testing procedure to be described in detail below. Although PVC is described as being a preferred material for the mandrel 10, it should be understood that the mandrel could be formed from various other types of plastics, metals or equivalent material while operating within the scope of the present disclosure.

The wall 16 of the mandrel 10 defines a smooth outer surface 24 and a smooth inner surface 22. The thickness of the wall 16 is selected to insure that the entire mandrel 10 is sufficiently rigid to prevent inward flexing during the testing procedure.

The portion of the system shown in FIG. 1 also includes a stimulation cuff 26, a reference blood pressure cuff 28 and a test blood pressure cuff 30. Although only a single test blood pressure cuff 30 is shown in FIG. 1, it should be understood that the system and method of the present disclosure can be utilized to evaluate the operation of multiple possible test blood pressure cuffs 30 of different sizes, materials, pneumatic connections, or construction methods.

The stimulation cuff 26 is a conventional blood pressure cuff that includes an inflatable bladder (not shown) contained within a portion of the overall length of the stimulation cuff 26. Although a cuff is shown, it should be understood that the stimulation cuff 26 could be any type of device that has a volume that can be varied in a similar manner to the bladder in a blood pressure cuff. The stimulation cuff 26 is attached to the surface of the mandrel 10 with its pneumatic tubing running immediately to the inside of the mandrel for connection to the NIBP simulation device. The stimulation cuff 26 would be expected to be a smaller cuff than the test cuff 30 or the reference cuff 28. In the embodiment shown in FIG. 1, the stimulation cuff 26 is a neo-natal blood pressure cuff that includes a pair of tubes 34 that are used to selectively control the bladder pressure and volume contained within the stimulation cuff 26. Although a neo-natal blood pressure cuff is selected to be the stimulation cuff 26 in the embodiment shown, various different types of available blood pressure cuffs could be utilized as the stimulation cuff. The neo-natal cuff is selected in the disclosed embodiment based upon its relatively small size relative to the reference blood pressure cuff 28 and the test blood pressure cuff 30. The tubes 34 are shown in FIG. 1 as being connected to a blood pressure simulation device 36, the operation of which will be described in much greater detail below. While the stimulation cuff is taken as a neonatal cuff in this example, any flexible volume of suitable size with tubes for pneumatic connection could be used as the stimulation cuff while operating within the scope of the present disclosure.

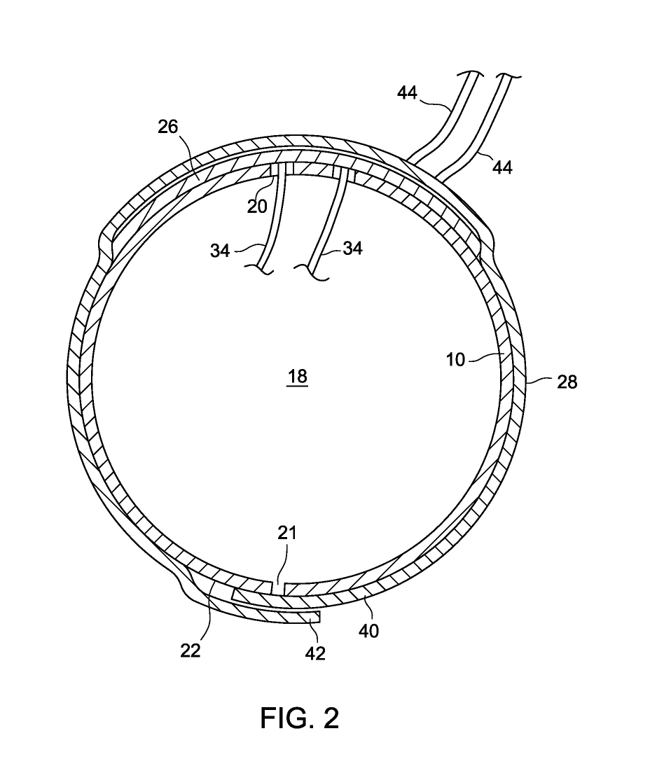

The stimulation cuff 26 can be selectively applied over the outer surface 22 of the support mandrel 10. For example, the attachment to the mandrel could be made with adhesive tape running along the edges of the stimulation cuff 26. When the stimulation cuff 26 is applied onto the outer surface 22 of the mandrel 10, the pair of tubes 34 can be threaded through the access openings 20 and into the open interior 18. The access openings 20 allow the tubes 34 to enter into the open interior for easy access and connection to the blood pressure simulator 36 without compression of the tubes 34. As illustrated in FIG. 2, the stimulation cuff 26 is placed in physical contact with the outer surface 22 of the mandrel 10. When positioned as such, the tubes 34 extend into the open interior 18 through the access openings 20.

Once the stimulation cuff 26 is attached to the support mandrel 10, the reference blood pressure cuff 28 can be attached over both the mandrel 10 and the stimulation cuff 26, as shown in FIG. 2. As described above, the stimulation cuff 26 is selected to have a size smaller than the reference blood pressure cuff 28 such that the reference blood pressure cuff 28 can be positioned to surround the entire stimulation cuff 26. As illustrated in FIG. 2, the reference cuff includes a first end 40 and a second end 42, which hold the reference cuff 28 in place. Typically, the first and second ends 40, 42 include some type of attachment material, such as a hook and loop fastener, to hold the first and second ends in the position shown in FIG. 2.

Referring back to FIG. 1, the reference cuff 28 also includes a pair of tubes 44 that can be connected to a pressure monitoring device 46. The output signal from the pressure transducer contained within the pressure monitoring device can be used to evaluate and compare the oscillometric signals from the reference and test cuffs.

The reference blood pressure cuff 28 is a standard cuff that has well known operating characteristics, that has been previously tested and evaluated, and is used to generate an output cuff pressure signal response that is used as the expected reference for mathematical and statistical comparison to the newly designed cuff performance when stimulated with the same signal from the stimulation cuff and mandrel construct. The reference blood pressure cuff 28 can be one of many different types of blood pressure cuffs currently available.

As illustrated in FIG. 1, the system and method of the disclosure further includes a test blood pressure cuff 30. The test blood pressure cuff 30 is a blood pressure cuff that is currently being developed and needs to be tested and evaluated before being introduced and sold for use with a blood pressure monitor. The test blood pressure cuff 30 has a similar configuration to the reference cuff 28 and includes tubes 44 that are connected to a pneumatic pressurization source. During development of the test blood pressure cuff, it is required that the cuff be evaluated to insure that the pressure transducer generates an output signal that correctly corresponds to the oscillation pulses from a patient.

During operation of the method of the present disclosure, the reference blood pressure cuff 28 and the test blood pressure cuff 30 are each separately positioned over the stimulation blood pressure cuff 26. In the embodiment shown in FIG. 2, the reference blood pressure cuff 28 is shown positioned over the stimulation cuff 26. However, the reference blood pressure cuff 28 is removed during the method of the disclosure and replaced with the test blood pressure cuff, as will be described in much greater detail below.

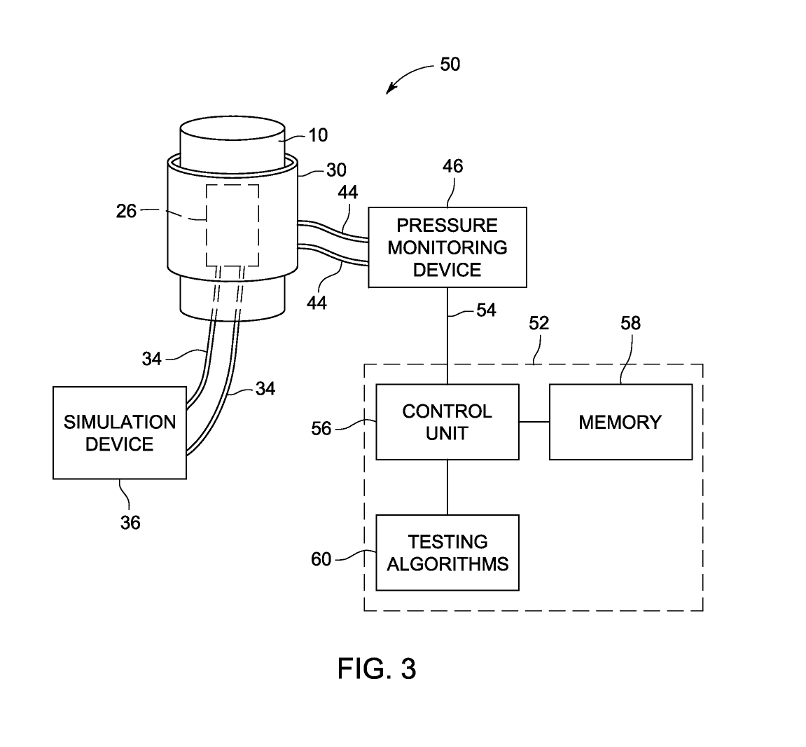

FIG. 3 illustrates one embodiment of the system 50 of the present disclosure. The system 50 can be operated to evaluate the operation of a test blood pressure cuff 30. The system 50 includes the support mandrel 10 and the stimulation cuff 26 positioned on the mandrel 10 outer surface. The stimulation cuff 26 is shown in the embodiment of FIG. 3 as connected to a blood pressure simulation device 36 through the pair of tubes 34. In addition to the blood pressure simulation device 36, an inflation device (e.g. a sphygmomanometer inflation bulb, not shown) is pneumatically connected to the setup to help control the pressure and volume of the stimulation cuff. In the embodiment shown, the blood pressure simulation device is an oscillometric blood pressure simulator that is operable to selectively create a series of pressure pulses relayed through the tubes 34. The blood pressure simulation device 36 is connected pneumatically to the stimulation cuff in order to provide a series of volume changing pulses that oscillate between two or more pressure levels to create a test pattern that is meant to simulate the volume changes due to the flow of blood through an artery of a patient. The test pattern created by the blood pressure simulation device 36 includes a set frequency of the pulses, the pressure size of each pulse in the stimulation cuff 26 and the number of the series of pulses that create the test pattern.

Since the stimulation cuff 26 includes an inflatable bladder that changes volume to create physiologically shaped pulses under the control of the simulation device 36, when the test blood pressure cuff 30 is positioned over the stimulation cuff, the pressure transducer contained within the pressure monitoring device 46 will generate a test signal that can be used for comparison. In the embodiment shown in FIG. 3, the pneumatic tubes 44 from the test blood pressure cuff 30 are connected to a pressure monitoring device 46. Although a pressure monitoring device 46 is shown in the embodiment of FIG. 3 is a typical blood pressure monitor altered to obtain pressure pulse waveform records, it should be understood that pneumatic connection to other types of monitoring devices that are capable of receiving the test signal from the pressure transducer in the pressure monitoring device and analyzing the received signal are possible. In the embodiment shown in FIG. 3, the blood pressure monitoring device 46 is a conventional DINAMAP blood pressure monitor that is used to obtain blood pressure readings from a patient but has been altered to simply obtain the pressure waveform of the test or reference cuff as a result of the test pattern being created in the stimulation cuff.

As illustrated in FIG. 3, the blood pressure monitoring device 46 is shown connected to a recording and analysis computational device 52. Although a recording and analysis computational device 52 is shown in the embodiment of FIG. 3, it should be understood that the operational steps and components of the device 52 could be integrated into the blood pressure monitor 46 while operating within the scope of the present disclosure.

The recording and analysis device 52 receives the output signal pressure transducer waveform from the pressure monitoring device 46 electronically by means of communication line 54. A typical example of the recording and analysis device 52 is a commonly available laptop computer. The output signal from the pressure transducer in the pressure monitoring device 46 is received and analyzed by a control unit 56. The control unit 56 is able to store the received test signal in a memory device 58. The recording and analysis device 52 can further include another memory location that stores testing algorithms, as illustrated by memory block 60. The testing algorithms stored in memory block 60 are used by the control unit 56 to compare the test signals from the pressure transducer in the test blood pressure cuff with stored reference signals. The stored reference signals contained within the memory 58 are obtained during an initial test phase in which the reference blood pressure cuff 28 replaces the test blood pressure cuff 30 to provide generation of a reference signal for comparison. The reference signal is generated based upon the test pattern created by the blood pressure simulator 36.

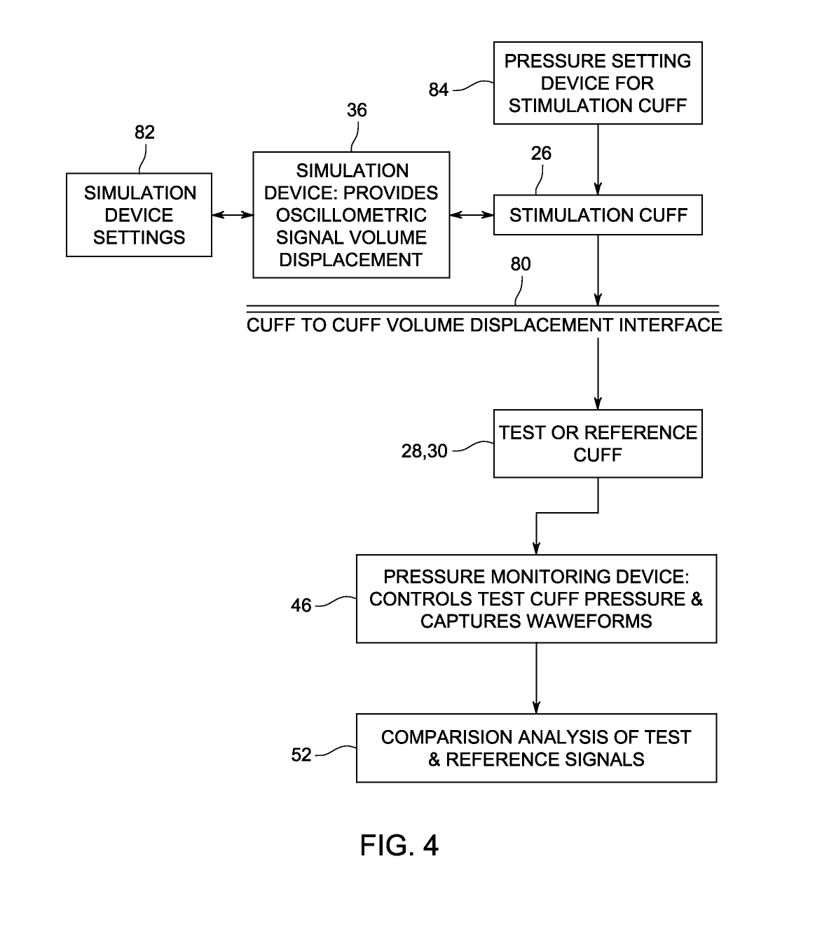

FIG. 4 is a schematic illustration of the operational connections and communication taking place in the testing method of the present disclosure. As illustrated in FIG. 4, the stimulation cuff 26 and either the test or reference cuff 28, 30 are coupled to each other across an interface 80. The interface 80 allows pressure oscillations created by the stimulation cuff 26 to be transmitted and detected at either the test or reference cuffs 28, 30.

The stimulation cuff 26 is coupled to the simulation device 36 such that the simulation device 36 can provide oscillometric signal volume displacement to the stimulation cuff 26 to provide a series of pulses that oscillate between two or more pressure levels to create a test pattern that simulates the flow of blood through an artery of a patient. The test pattern is controlled by simulation device settings shown by reference numeral 82. The simulation device settings shown by reference numeral 82 can include the frequency of the pulses, the pressure size of each pulse in the stimulation cuff 26 and the number of the series of pulses that create the test pattern. Block 84 in FIG. 4 illustrates a pressure setting device that helps control the pressure and volume of the stimulation cuff. As described previously, an inflation bulb could be pneumatically connected to the stimulation cuff 26 to create the pressure and volume settings for the stimulation cuff.

The test or reference cuff 28, 30 is shown in FIG. 4 coupled to the pressure monitoring device 46. The pressure monitoring device not only receives the pressure information from the test or reference cuff, the pressure monitoring device 46 also controls the initial inflation pressure for either the test or reference cuff. Since the output signals from the test and reference cuffs are compared to each other, it is important that the pressure monitoring device 46 controls the test and reference cuffs to be inflated to a similar pressure and volume such that the result after detecting the test pulses can be accurately compared.

In the embodiment shown in FIG. 4, the recording and analysis device 52 is illustrated as receiving information from the pressure monitoring device 46 such that the testing and analysis device 52 can compare the test and reference signals as previously described.

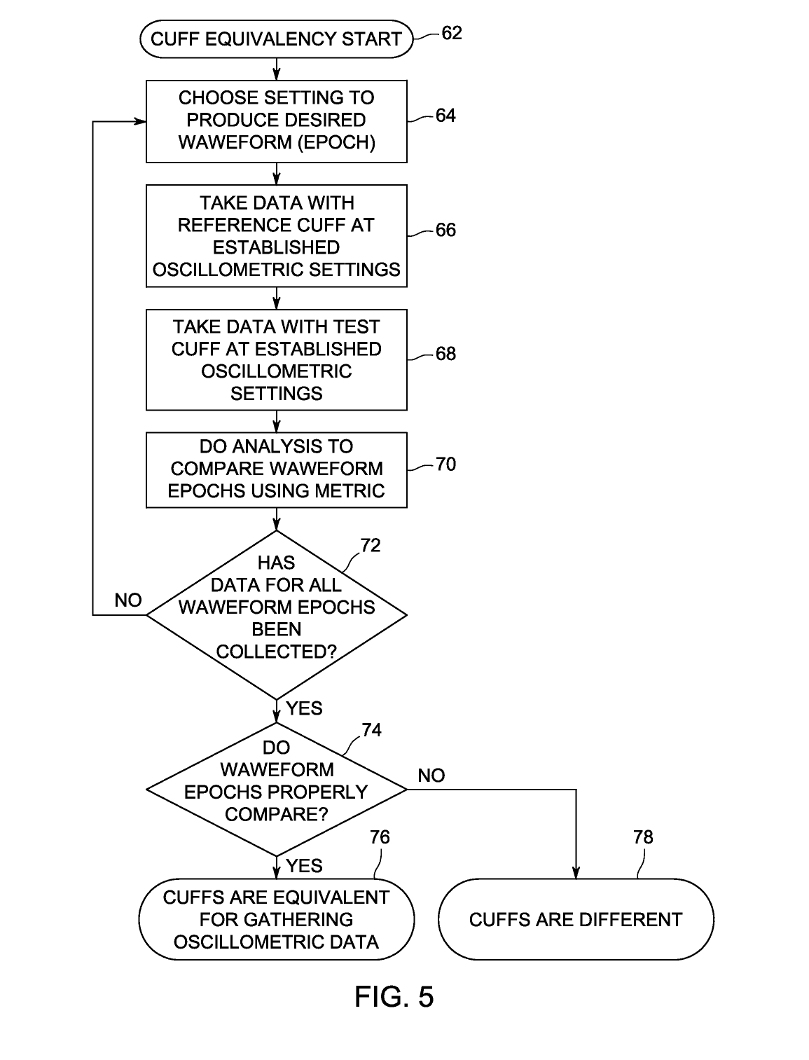

Referring now to FIG. 5, one exemplary method of utilizing the system shown in FIG. 3 is described. Although a single exemplary method is shown in the flowchart of FIG. 5, various other methods could be utilized while operating within the scope of the present disclosure.

As illustrated in FIG. 5, the method of the disclosure begins with step 62. In step 62, the system begins the process of determining the equivalency between a test blood pressure cuff and a reference blood pressure cuff. As described previously, the reference blood pressure cuff can be any type of blood pressure cuff that is currently available and has operating characteristics that are known to be appropriate for oscillometric estimation of blood pressure.

In step 64, the blood pressure simulation device 36 is adjusted to create a desired test pattern to produce a desired waveform during a single epoch. As described previously, the test pattern created by the blood pressure simulation device creates a series of volume changes in the stimulation cuff. The volume changes in the stimulation cuff are designed to replicate a typical pulse and pressure pattern from a patient. The settings from the blood pressure simulation device 36 can be adjusted to create sets of test patterns to simulate various different pressures, frequencies and other parameters during a verification of a newly designed cuff.

Initially, the reference blood pressure cuff 28 is positioned around both the mandrel and the stimulation cuff. The reference blood pressure cuff is properly inflated and the pressure transducer generates a reference signal during the generation of the test pattern by the stimulation cuff. The reference signal is received by the pressure monitoring device 46, as shown in FIG. 3. The pressure monitoring device 46 obtains and relays the reference signal using a pressure transducer contained in the monitoring device, where it is then received by a control unit 56. The control unit 56 stores the reference signal from the pressure transducer of the reference blood pressure cuff in a memory device 58.

Once the reference signal has been received and stored, the reference blood pressure cuff is removed and the test blood pressure cuff is installed over both the mandrel and the stimulation cuff. Once the test blood pressure cuff has been positioned over the stimulation cuff, the blood pressure simulation device is again operated to produce the same test pattern that was used to create the reference signal, as indicated in step 68. This is accomplished by controlling the pressure and volume of the various cuffs. For example, to create the same test patterns in the test and reference cuffs done at different sequential times, the stimulation cuff should have the same pressure and volume so that the NIBP simulator produces the same waveform pressure pattern. Similarly, the test and reference cuffs must also be set up during their different testing periods to have close to the same volumes and pressures, to provide the same experimental conditions for both cuffs. Since the blood pressure simulation device would then create the same test signal, the data obtained from the transducer contained within the waveform monitoring device from the test blood pressure cuff should closely correspond to the data from the reference blood pressure cuff.

In step 70, the control unit 56 does an analysis between the test signal from the test blood pressure cuff and the reference signal from the reference blood pressure cuff. The analysis conducted in step 70 can be completed using test algorithms from the memory device 60.

In step 72, a determination is made as to whether the entire set of waveforms have been collected for the various different epochs that are created by the test system to show equivalency of the reference and test cuff. Until all of the test and reference comparison waveforms have be obtained the process returns to step 64 and another setting configuration of cuff pressure and volume is used to generate another test pattern to acquisition another epoch of waveform data. The steps described above continue until all of the waveform epochs have been collected, as indicated in step 72. Once all the waveform epochs have been obtained, the results of the comparison algorithms for each epoch of the test signal and the reference signal are compared to each other in step 74. The comparison carried out in step 74 is typically carried out using the recording and analysis device 52. However, the functionality and components of the recording and analysis device 52 could be incorporated directly into the pressure waveform monitoring device 46, as previously described.

At step 74 of the process it is determined if the epochs properly compare based on the use of the one or more of the algorithms set forth below, the conclusion in step 76 that the reference blood pressure cuff and the test blood pressure cuff are functional equivalents for gathering oscillometric data can be made. However, if the result of the analysis using the algorithms determines that the waveform epochs do not properly compare, the process at step 78 concludes that the test blood pressure cuff and the reference blood pressure cuff are different from each other and thus cannot be claimed as functional equivalents.

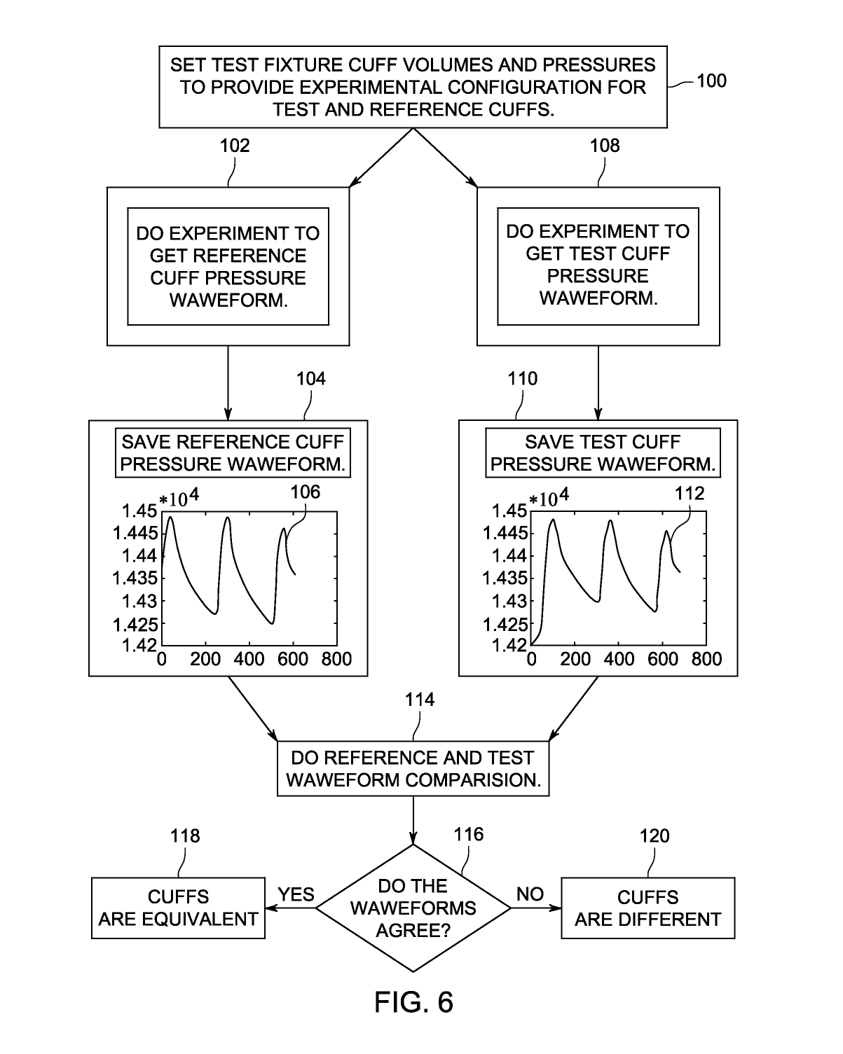

FIG. 6 provides another data and process flowchart that illustrates the system and method of the present disclosure. In step 100, the simulation device that is used to dictate the operation of the stimulation cuff is programmed and configured to generate multiple different cuff pressure and volume settings. The cuff pressure and volume settings are used by the simulation device to create different test pulse patterns that can be used to determine whether a test blood pressure cuff is a functional equivalent to a known, reference blood pressure cuff.

When the reference cuff is placed over the stimulation cuff and the stimulation cuff is controlled to generate a series of pulses to create the test pattern, the system operates to determine a reference cuff pressure waveform, as illustrated in step 102. As illustrated in block 104, the reference cuff pressure waveform 106 is saved for later comparison and analysis. As described in FIG. 3, the reference cuff pressure waveform 106 is stored in memory 58 of the recording and analysis device 52. However, it should be understood that the reference cuff pressure waveform, which is generally referred to as the reference signal from the reference blood pressure cuff, could be stored at other locations while operating within the scope of the present disclosure.

Once the reference signal has been recorded and stored, the system proceeds to step 108 and positions the test reference cuff around the stimulation cuff and the mandrel. The simulation device creates the same test pattern in the stimulation cuff such that the test blood pressure cuff generates a test cuff pressure waveform. As illustrated in step 110, the test cuff pressure waveform is saved as a test cuff output signal 112.

Once the reference signal and the output signal from the test pressure cuff have been recorded and stored, the system proceeds to step 114. In step 114 the method utilizes one of several testing algorithms to compare the reference signal recorded from the reference pressure cuff to the output signal recorded from the test pressure cuff. As illustrated in FIG. 3, the testing algorithms 60 are shown stored on some type of memory device within the recording and analysis device 52. However, it should be understood that the testing algorithms 60 could be stored in the memory 58 or at some other location while operating within the scope of the present disclosure.

Listed below are several sample test algorithms comprising various calculated output quantities that can be utilized while operating within the scope of the present disclosure, although other testing algorithms and calculated output quantities are also contemplated:

Metric 1. Normalized Sum Squared Error.

This metric evaluates the sample by sample error for a given epoch of the oscillometric waveform. An epoch is a segment of a cuff pressure waveform vs. time taken using the test or reference cuff at a given setting. The intent for this metric is to take epochs from the test and reference waveform that are time aligned based upon the occurrence of some common marking event like the maximum positive slope of a pulse. To actually decide if the test and reference cuffs are equivalent, a set of epochs from a variety of settings would be used. For each of the normalized sum squared error (n.s.s.e.) values, a threshold comparison would be made. For the claim that equivalency exists, all the n.s.s.e. values for the setting pairs would have to be less than the established threshold. Two quantities need to be calculated for this metric for every pair of epoch settings: the reference energy and the normalized sum squared error.

$$energy ( reference ( t ) ) = {\sum }_{n = 0}^{m} {( reference ( {t}_{n} ) )}^{2}$$

$$n . s . s . e ( reference ( t ) , test ( t ) ) = \frac{{\sum }_{n = 0}^{m} {( test ( {t}_{n} ) - reference ( {t}_{n} ) )}^{2}}{energy ( reference ( t ) )}$$

Metric 2. Frequency Domain Peak Error

This metric compares the peaks of a frequency spectrum. An FFT would be taken of the time domain epochs of the test and reference waveforms. The FFT taken for a single epoch will contain frequency component peaks. The magnitude of the FFT values would be used to construct the quantity used for this metric. It is these peaks at the same frequency (ωₙ) which will be used in the comparison. If the frequency peaks agree, then the signals can be said to be equivalent. The scaled frequency domain peak error (f.d.peak.e.) must be less than an established threshold at each setting (each epoch) for the claim of equivalency to be made. The following calculation would be an example of the needed calculation for each epoch.

$$f . d . peak . e . ( n , reference ( ω ) , test ( ω ) ) = \frac{\vert \vert reference ( {ω}_{n} ) \vert - \vert test ( {ω}_{n} ) \vert \vert}{( \vert reference ( {ω}_{n} ) \vert + \vert test ( {ω}_{n} ) \vert ) / 2}$$

Metric 3. Frequency Domain Correlation

Again, a calculation which evaluates the pattern of the entire frequency spectrum would be extremely useful in deciding equivalency. A frequency domain correlation (f.d.c.) metric would be a way of doing this. Again, the magnitude of the FFT values would be used to construct the waveform used in this analysis. The frequency domain correlation would be compared to an established threshold for all the relevant settings using the equivalency device disclosed. As with all the other metrics, each setting provides an epoch to be analyzed for the test and reference cuffs. This metric has an advantage that precise oscillation size would not be necessary to get a good comparison; this might make it unnecessary to get settings very near each other for comparison. I.E. cuff wrap, source cuff pressure, simulator reproducibility, etc. could be more easily set if this metric is used.

$$d . c . c . ( siganl ( ω ) ) = \frac{1}{m} {\sum }_{n = 0}^{m} \vert signal ( {ω}_{n} ) \vert$$

$$f . d . c . ( reference ( ω ) , test ( ω ) ) = \frac{{\sum }_{n = 0}^{m} ( \vert test ( {ω}_{n} ) \vert - d . c . c . ( test ( ω ) ) \cdot ( \vert reference ( {ω}_{n} ) \vert - d . c . c . ( test ( ω ) )}{\sqrt{\begin{matrix}( {\sum }_{n = 0}^{m} {( \vert test ( {ω}_{n} ) \vert - d . c . c . ( test ( ω ) ) )}^{2} \cdot \\ {\sum }_{n = 0}^{m} {( \vert reference ( {ω}_{n} ) \vert - d . c . c . ( reference ( ω ) ) )}^{2} )\end{matrix}}}$$

Metric 4. Frequency Domain Band Energy

A similar metric could be used to evaluate the energy in established frequency bands for each epoch obtained from the equivalency device settings for the test and reference cuffs. Once again, thresholds would be established and met in order to claim equivalency between a test and reference cuff. The following calculation would be done for a particular band in a particular epoch. The frequency domain band energy (f.d.b.e.) must be scaled (s.f.d.band.e.) or normalized for threshold comparison.

$$f . d . b . e ( signal\_FFT ( ω ) ) = {\sum }_{n = i}^{j} {\vert signal\_FFT ( {ω}_{n} ) \vert}^{2}$$

$$s . f . d . band . e . ( reference ( ω ) , test ( ω ) ) = \frac{\vert f . d . b . e . ( refernce\_FFT ( ω ) ) - f . d . b . e ( test\_FFT ( ω ) ) \vert}{( f . d . b . e . ( refernce\_FFT ( ω ) ) + f . d . b . e . ( test\_FFT ( ω ) ) ) / 2}$$

Although various different quantities, metrics and algorithms can be utilized for comparing the test signal and the reference signal, other types of algorithms could be utilized while operating within the scope of the present disclosure. The focus of each of the algorithms is to compare the test signal to the reference signal to determine whether the test signal indicates that the test blood pressure cuff is operating properly.

Referring back to FIG. 6, the result of the testing algorithms described above is a determination in step 116 whether the reference signal from the reference cuff and the output signal from the test blood pressure cuff agree. If the system determines in step 116 that the waveforms agree, the system generates a result in step 118 indicating that the reference cuff and the test cuff are functional equivalents. However, if the result of the testing algorithms indicates that the waveforms do not agree, the system determines in step 120 that the reference cuff and the test cuff are not functional equivalents.

As described above, the present disclosure provides a method and system to provide a comparison between the volume transducing properties of a test blood pressure cuff and a reference blood pressure cuff to make sure that the test blood pressure cuff can perform as desired. The system utilizes a stimulation cuff rather than a human patient since the stimulation cuff can be operated to provide a consistent test pattern to both the reference blood pressure cuff and the test blood pressure cuff. This type of bench study provides an equivalent, repeatable test pattern that can test the operational characteristics of a test blood pressure cuff without using human subjects. The stimulation cuff provides an equivalent test that utilizes a volume change that is measured by the pressure transducer in the pressure monitoring device.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method of evaluating a functionality of a test blood pressure cuff, comprising:
positioning a stimulation device having a variable volume on to a support mandrel;
positioning the test blood pressure cuff around the stimulation device and the mandrel;
selectively inflating and deflating the stimulation device; and
monitoring an output pressure signal from the test blood pressure cuff to determine whether the test blood pressure cuff is operating properly.

2. The method of claim 1 wherein the stimulation device is a stimulation cuff connected to a simulation device that is operable to create oscillometric pulse sequence patterns in the stimulation cuff.

3. The method of claim 2 wherein the simulation device changes the volume of a bladder in the stimulation cuff to create oscillations which are then coupled to the test cuff positioned around the stimulation cuff.

4. The method of claim 1 wherein the output signal from the test blood pressure cuff is compared to a reference signal to determine whether the test blood pressure cuff is operating properly.

5. The method of claim 1 wherein the output signal is generated by a pressure transducer in a pressure monitoring device.

6. The method of claim 5 wherein a first output quantity is calculated using the test cuff pressure signal and a second output quantity is calculated using the reference cuff pressure signal, wherein a comparison of the first output quantity to the second output quantity is made.

7. The method of claim 6 wherein the simulation device changes the volume and pressure of the stimulation cuff in a series of pulses to create a test pattern.

8. The method of claim 7 wherein both the output signal and the reference signal are generated based upon the test pattern.

9. A method of evaluating the functionality of a test blood pressure cuff, comprising:
positioning a stimulation cuff on to a support mandrel;
positioning a reference blood pressure cuff around the stimulation cuff and the mandrel;
selectively inflating and deflating the stimulation cuff to create a setting to produce a test pattern consisting of a series of pulses;
recording a reference signal from the reference blood pressure cuff created by the test pattern as a reference signal;
removing the reference blood pressure cuff;
positioning the test blood pressure cuff around the stimulation cuff and the mandrel;
selectively inflating and deflating the stimulation cuff to create the same setting to produce the same test pattern consisting of a series of pulses; and
comparing an output signal using the test blood pressure cuff to the reference signal using the reference blood pressure cuff to evaluate the test blood pressure cuff.

10. The method of claim 9 wherein the stimulation cuff is connected to a simulation device that selectively changes the pressure and volume of the stimulation cuff to create the test pattern.

11. The method of claim 9 wherein the reference blood pressure cuff and the test blood pressure cuff are each connected to a pressure monitor device to obtain both the reference signal from the reference blood pressure cuff and the output signal from the test blood pressure cuff.

12. The method of claim 11 wherein the output signal from the test blood pressure cuff is generated by a pressure transducer in the pressure monitoring device.

13. The method of claim 9 wherein the output signal from the blood pressure cuff is compared to the reference signal by a control unit in a recording and analysis device.

14. The method of claim 13 wherein the test algorithms are stored in a memory location within the recording and analysis device.

15. The method of claim 9 further comprising the step of selectively adjusting the size of the mandrel.

16. A system for evaluating the functionality of a blood pressure cuff, comprising:
a support mandrel;
a stimulation cuff selectively located on to the support mandrel;
a simulation device connected to the stimulation cuff and operable to change the pressure and volume of the stimulation cuff in a test pattern;
a reference blood pressure cuff wrapped around the stimulation cuff and the mandrel, wherein the reference blood pressure cuff generates a reference signal in response to the test pattern;
a test blood pressure cuff wrapped around the stimulation cuff and the mandrel, wherein the test blood pressure cuff generates an output signal in response to the same test pattern; and
a recording and analysis device operable to compare the reference signal from the reference blood pressure cuff and the output signal from the test blood pressure cuff.

17. The system of claim 16 wherein the simulation device changes the pressure and volume of the stimulation blood pressure cuff in a series of pulses to create the test pattern.

18. The system of claim 17 wherein the pressure monitoring device includes a pressure transducer that generates the test signal.

19. The system of claim 16 wherein the recording and analysis device includes memory to store the reference signal and utilizes at least one testing algorithm to compare the reference output signal to the test output signal.

20. The system of claim 16 wherein the support mandrel is adjustable.
